(19) United States
(12) Patent Application Publication
(10) Pub. No.: US 2015/0355129 A1
(43) Pub. Date: Dec. 10, 2015

(54) SYSTEMS AND METHODS FOR DETECTING SUBSTANCES IN BODILY FLUIDS

(71) Applicant: Avails Medical, Inc., Palo Alto, CA (US)

(72) Inventor: Oren S. KNOPFMACHER, Palo Alto, CA (US)

(73) Assignee: Avails Medical, Inc., Palo Alto, CA (US)

(21) Appl. No.: 14/297,603

(22) Filed: Jun. 5, 2014

(51) Int. Cl. G01N 27/327

(52) U.S. Cl. CPC G01N 27/3272

(57) ABSTRACT

Various devices, systems and methods for determining a parameter of and/or detecting chemical and biological substances in bodily fluid are described herein. A device or system may include a substrate. An active sensor having an electrical characteristic and/or a control sensor may be disposed on the substrate. In certain variations, a differential between a first signal from the active sensor, and a second signal from the control sensor may be used to determine a parameter of the chemical or biological substance in the sample of bodily fluid.

### FIELD OF THE INVENTION

The present systems and methods relate generally to devices, systems and methods for detecting various parameters of a chemical or biological substance in bodily fluid.

### BACKGROUND

Integration of biosensors on a small scale for e.g., in-home testing is increasingly being favored by healthcare providers, however it has been a challenge for years. Optical-based biosensors require bulky detection equipment and access to power supplies. Vibration sensitive biosensors (AFM, crystal-quartz balance etc.) cannot be built into a portable device since background vibration will interfere with the signal. Biosensors made from electrical components have been considered as a good solution, however existing biosensors face several problems including limitations caused by electrostatic screening in complex media. Several methods to circumvent this problem including sample dilution and pulsed electrical properties have been explored, resulting in additional sample processing steps and the dilution of the analyte, or adding complexity to the device design. In addition, reference and calibration processes prior to use of the biosensors complicates their use.

Existing biosensors used to detect substances in bodily fluid suffer from a number of other limitations as well. For example, existing biosensors may be utilized for analyte detection; however, due to the inability to control various environmental factors surrounding the sample of bodily fluid and the biosensor, signals associated with this detection are often not accurate, not reproducible and do not provide a reliable or stable readout.

As a result of the above limitations and restrictions, there is a need for an improved device, system and method for detecting chemical and biological substances in bodily fluid that minimizes or eliminates such limitations and restrictions.

### BRIEF SUMMARY

Various electrical devices, systems and methods for determining a parameter of and/or detecting a chemical and biological substances in bodily fluid are described herein.

In certain variations, a device or system for determining a parameter of and/or detecting a chemical and biological substances in bodily fluid is described herein. The device or system may include a substrate having an active sensor and a control sensor. The active sensor may include a first electrical component having an electrical characteristic. At least one functionalized structure may be disposed on the substrate, active sensor or in a vicinity of the substrate, e.g., in a location separate from the substrate. The functionalized structure may be configured to couple to the chemical or biological substance, where the bound chemical or biological substance undergoes a reaction which produces a product. The product interacts with the first electrical component which results in a change in the electrical characteristic of the first electrical component.

The control sensor includes a second electrical component having an electrical characteristic, where coupling of the chemical or biological substance to the active sensor or the control sensor does not result in a change in the electrical characteristic of the second electrical component. A differential between a first signal from the first electrical component of the active sensor, the first signal being indicative of a change in the electrical characteristic or the changed electrical characteristic, and a second signal from the second electrical component of the control sensor is used to determine the parameter of the chemical or biological substance in the sample of bodily fluid.

In certain variations, an analyzer configured to analyze the signals received from the first and second electrical components and to determine the differential signal may be provided. A reader in communication with the analyzer, and configured to provide an electronic read-out of the determined parameter may also be provided.

In certain variations, a method for determining a parameter of a chemical or biological substance in a sample of bodily fluid may include one or more of the following steps. A substrate having an active sensor and a control sensor, wherein the active sensor comprises a first electrical component having an electrical characteristic, wherein at least one functionalized structure is disposed on or in a vicinity of the substrate or the active sensor and wherein the control sensor comprises a second electrical component having an electrical characteristic is provided. The chemical or biological substance is coupled or bound to a functionalized structure, wherein the bound chemical or biological substance undergoes a reaction thereby producing a product. The product interacts with the first electrical component which results in a change in the electrical characteristic of the first electrical component, while not resulting in a change in the electrical characteristic of the second electrical component. A differential is determined between a first signal from the first electrical component of the active sensor, the first signal being indicative of the changed electrical characteristic or the change in the electrical characteristic, and a second signal from the second electrical component of the control sensor. The differential is used to determine the parameter of the chemical or biological substance in the sample of bodily fluid; and an electronic read-out of the determined parameter is provided to a user.

### BRIEF DESCRIPTION OF THE SEVERAL VIEWS OF THE DRAWINGS

FIG. 1 illustrates a variation of a system for detecting a chemical or biological substance in bodily fluid including a substrate having active and control sensors and an analyzer, and a reader.

FIG. 2 illustrates a schematic diagram of the signal detection and read out of the system according to FIG. 1.

FIG. 3A illustrates a substrate having an active sensor and a control sensor where functionalized structures are disposed on the active sensor.

FIG. 3B illustrates a side view of the substrate of FIG. 3A, where a target chemical or biological substance is bound to a functionalized structure and undergoes a reaction which produces ions which diffuse to the surface of the active sensor.

FIG. 4A illustrates a substrate having an active sensor and a control sensor where functionalized structures are disposed on the substrate, adjacent to the active sensor.

FIG. 4B illustrates a side view of the substrate of FIG. 4A, where a target chemical or biological substance is bound to the functionalized structure and undergoes a reaction which produces ions which diffuse to the surface of the active sensor.

FIG. 5 illustrates a side view of an active sensor having functionalized structures disposed thereon, where first and second moieties of a chemical or biological substance undergo a competing reaction which produces ions which diffuse to the surface of the active sensor.

FIG. 6 illustrates various functionalization schemes and secondary reactions that a bound chemical or biological substance may undergo.

FIG. 7 illustrates various reactions that a bound chemical or biological substance may undergo.

### DETAILED DESCRIPTION

Variations of the devices are best understood from the detailed description when read in conjunction with the accompanying drawings. It is emphasized that, according to common practice, the various features of the drawings may not be to-scale. On the contrary, the dimensions of the various features may be arbitrarily expanded or reduced for clarity and not all features may be visible or labeled in every drawing. The drawings are taken for illustrative purposes only and are not intended to define or limit the scope of the claims to that which is shown.

In certain variations, a device, e.g., an electrical device or biosensor, for determining a parameter of and/or for detecting a chemical or biological substance in bodily fluid is provided. The device includes a substrate. One or more active sensors and one or more control sensors may be disposed on the substrate.

The active sensor includes one or more first electrical components having an electrical characteristic or property. One or more functionalized structures are disposed on, near or in a vicinity of the substrate or active sensor. The functionalized structure is configured to interact with, e.g., couple with or bind, the chemical or biological substance, e.g., one or more moieties of the chemical or biological substance. The interaction of the chemical or biological substance with the functionalized structure results in a change in the electrical characteristic or property of the electrical component of the active sensor.

The control sensor comprises one or more second electrical components having an electrical characteristic. However, the control sensor is configured such that interaction of the chemical or biological substance with the active sensor and/or the control sensor does not result in a change in the electrical characteristic of the second electrical components of the control sensor.

The first electrical component of the active sensor produces a signal, where the signal is indicative of the change in the electrical characteristic of the first electrical component caused by the interaction of the functionalized group with the chemical or biological substance in the bodily fluid. For example, the signal may be indicative of a changed current, voltage, capacitance or other electrical characteristic. The interaction between the functionalized group and the chemical or biological substance may take place on the active sensor or off the active sensor or substrate in a separate location. Simultaneously, the second electrical component of the control sensor produces a control signal. The differential between the signal from the first electrical component of the active sensor, and the signal from the second electrical component of the control sensor is used to determine the parameter of the chemical or biological substance in the sample of bodily fluid. Indeed, the device, via the simultaneous use and detection of a control sensor, provides a self-calibration.

The differential signal may be used to determine a variety of parameters or characteristics of the chemical or biological substance, or to detect the presence of the chemical or biological substance. In certain variations, the differential signal may be used to determine the concentration of the chemical or active substance. The differential signal may be used to determine the concentration of a variety of ions present in the chemical or biological substance or in the sample of bodily fluid. For example, the differential signal may be used to determine the pH of the chemical or biological substance.

In certain variations, the differential between the signal produced by the active sensor and the signal produced by the control sensor is indicative of, corresponds to, or is used to determine the concentration of the chemical or biological substance in the sample of bodily fluid. Indeed, the control sensor signal may correspond to a known concentration, such that the differential between the control signal and the signal from the active sensor may be used to deduce or determine the concentration of the chemical or biological substance in the sample of bodily fluid.

The differential between the signal of the active sensor and the signal of the control sensor may be the differential change (ΔS) in an electrical characteristic, e.g., current, voltage, capacitance, resistance or threshold voltage, of the active sensor (S1) vs the control sensor (S2), where the differential signal is (ΔS=S1−S2).

In other variations, the signal produced by the active sensor, which is indicative of the changed electrical characteristic or the change in the electrical characteristic of the first electrical component which change occurs as a result of the interaction of the functionalized group with the chemical or biological substance, may be indicative of a changed current, voltage, capacitance or other electrical characteristic. For example, the signal or detected current may correspond to a known concentration, such that the concentration can be deduced from the detected current, or current change, or the concentration may be deduced from a detected change in another electrical characteristic or property which corresponds to a known concentration.

The functionalized structure is configured to interact with the chemical or biological substance of the sample of bodily fluid. As described supra, the interaction of the chemical or biological substance with the functionalized structure may result in a change in the electrical characteristic or property of the electrical component of the active sensor.

In any of the variations described herein, the electrical components may include a transistor, a capacitor, a resistor or an inverter or any other suitable electrical component known to persons have ordinary skill in the art.

A variety of interactions between the chemical or biological substance and the functionalized structure and/or related reactions are contemplated, where such interactions and/or reactions result in a change, or cause a change, in the electrical characteristic or property of the electrical component of the active sensor.

In one variation, one or more functionalized structures are disposed on the active sensor and are configured to bind to the chemical or biological substance. The binding of the chemical or biological substance by the functionalized structure results in a change in an electrical characteristic of the electrical component of the active sensor. For example, the binding of a charged moiety or ion of a chemical or biological substance by a functionalized structure may result in an increase or decrease in charge density on or in a vicinity of the active sensor or a change in current.

In another variation, one or more functionalized structures are disposed on the substrate or the active sensor, and are configured to bind to the chemical or biological substance. The binding of the chemical or biological substance by the functionalized structure produces one or more ions which diffuse to the surface of the active sensor and cause a change in an electrical characteristic of the electrical component of the active sensor. For example, the produced ions may come into contact with, bind or otherwise interact with the active sensor, e.g., causing an increase or decrease in charge density of the active sensor or a change in current. Optionally, the functionalized structures may be disposed in another location, separate from the substrate. The produced ions may then flow over the surface of the active sensor, and interact with the active sensor, causing a change in the electrical characteristic of the electrical component of the active sensor.

In another variation, one or more functionalized structures are disposed on the substrate or the active sensor, and are configured to bind to the chemical or biological substance. The bound chemical or biological substance undergoes a reaction with one or more reagents, thereby producing one or more ions which diffuse to the surface of the active sensor and cause a change in an electrical characteristic of the electrical component of the active sensor. For example, the produced ions may come into contact with, bind or otherwise interact with the active sensor, e.g., causing an increase or decrease in charge density of the active sensor or a change in current. Optionally, the functionalized structures may be disposed in another location, separate from the substrate. Where the reaction takes place in a location which is separated from the substrate, the produced ions may flow to and over the surface of the active sensor, and interact with the active sensor, causing a change in the electrical characteristic of the electrical component of the active sensor.

In another variation, the one or more functionalized structures may be in the form of a permeable membrane or other filter, which is disposed on the active sensor. The membrane or filter is configured to allow for the passage of the target chemical or biological substance or a produced ion, such that the substance or ion may interact with the active sensor, while the membrane or filter blocks or restricts the passage of other moieties or ions, e.g., based on size or other property. The ions may be produced as a result of the binding of the chemical or biological substance by the functionalized structure or as a result of a reaction between a bound substance and a reagent. The ions may diffuse or flow, from a local or remote location, over the surface of the active sensor, after passing through a membrane of filter, and cause a change in an electrical characteristic of the electrical component of the active sensor. For example, the produced ions may come into contact with, bind or otherwise interact with the active sensor, e.g., causing an increase or decrease in charge density of the active sensor or a change in current. Optionally, the membrane, filter or other functionalized structure may capture the target substance or ions, but allow the passage of other non-target ions. Optionally, a membrane, filter or other functionalized structure may block background charge, where a charge or lack of charge may be detected when a particle flows through a membrane and past the sensor.

In certain variations, a device, e.g., an electrical device or a biosensor, for determining a parameter of and/or for detecting a chemical or biological substance in bodily fluid is provided. The device includes a substrate. One or more active sensors may be disposed on the substrate.

The active sensor includes one or more first electrical components having an electrical characteristic or property. One or more functionalized structures are disposed on, near or in a vicinity of the substrate or active sensor. The functionalized structure is configured to interact with, e.g., couple with or bind, the chemical or biological substance, e.g., one or more moieties of the chemical or biological substance. The bound chemical or biological substance undergoes a reaction thereby producing a product. The product interacts with the first electrical component which results in a change in the electrical characteristic of the first electrical component. A signal from the first electrical component, the signal being indicative of the changed electrical characteristic or the change in the electrical characteristic, may be used to determine the parameter of the chemical or biological substance in the sample of bodily fluid.

The signal from the first electrical component of the active sensor may be used to determine a variety of parameters or characteristics of the chemical or biological substance, or to detect the presence of the chemical or biological substance. In certain variations, the signal may be used to determine the concentration of the chemical or active substance. The signal may be used to determine the concentration of a variety of ions present in the chemical or biological substance. For example, the signal may be used to determine the pH of the chemical or biological substance.

In certain variations, the signal produced by the active sensor is indicative of, corresponds to, or is used to determine the concentration of the chemical or biological substance in the sample of bodily fluid. Indeed, the signal may correspond to a known concentration, such that the signal from the active sensor may be used to deduce the concentration of the chemical or biological substance in the sample of bodily fluid.

In other variations, the signal produced by the active sensor, which is indicative of the changed electrical characteristic or the change in the electrical characteristic of the first electrical component, may be indicative of a changed current, voltage, capacitance or other electrical characteristic. For example, the signal or detected current may correspond to a known concentration, such that the concentration can be deduced from the detected current.

In any of the variations described herein, the electrical components may include a transistor, a capacitor, a resistor or an inverter or any other suitable electrical component known to persons have ordinary skill in the art.

A variety of interactions between the chemical or biological substance and the functionalized structure and/or related reactions are contemplated, where such interactions and/or reactions result in a change, or cause a change, in the electrical characteristic or property of the electrical component of the active sensor.

In one variation, one or more functionalized structures are disposed on the substrate or the active sensor, and are configured to bind to the chemical or biological substance. The binding of the chemical or biological substance by the functionalized structure produces one or more ions which diffuse to the surface of the active sensor and cause a change in an electrical characteristic of the electrical component of the active sensor. For example, the produced ions may come into contact with, bind or otherwise interact with the active sensor, e.g., causing an increase or decrease in charge density of the active sensor or a change in current. Optionally, the functionalized structures may be disposed in another location, separate from the substrate. The produced ions may then flow over the surface of the active sensor, and interact with the active sensor, causing a change in the electrical characteristic of the electrical component of the active sensor.

In another variation, one or more functionalized structures are disposed on the substrate or the active sensor, and are configured to bind to the chemical or biological substance. The bound chemical or biological substance undergoes a reaction with one or more reagents, thereby producing one or more ions which diffuse to the surface of the active sensor and cause a change in an electrical characteristic of the electrical component of the active sensor. For example, the produced ions may come into contact with, bind or otherwise interact with the active sensor, e.g., causing an increase or decrease in charge density of the active sensor or a change in current. Optionally, the functionalized structures may be disposed in another location, separate from the substrate. Where the reaction takes place in a location which is separated from the substrate, but the produced ions may flow over the surface of the active sensor, and interact with the active sensor, causing a change in the electrical characteristic of the electrical component of the active sensor.

In one variation, the bound chemical or biological substance (on the substrate or in a remote location) may undergo a reaction which produces or results in the release of one or more ions which flow over the active sensor and cause a change in pH or other ion concentration. For example, the change in pH may be detected by the first electrical component of the active sensor, which may have a proton sensitive layer disposed thereon. The change in pH or other ion concentration may cause a change in the electrical characteristic of the first electrical component.

In another variation, the one or more functionalized structures may be in the form of a permeable membrane or other filter, which is disposed on the active sensor. The membrane or filter is configured to allow for the passage of the target chemical or biological substance or a produced ion, such that the substance or ion may interact with the active sensor, while the membrane or filter blocks or restricts the passage of other moieties or ions, e.g., based on size or other property. The ions may be produced as a result of the binding of the chemical or biological substance by the functionalized structure or as a result of a reaction between a bound substance and a reagent. The ions may diffuse or flow, from a local or remote location, over the surface of the active sensor, after passing through a membrane of filter, and cause a change in an electrical characteristic of the electrical component of the active sensor. For example, the produced ions may come into contact with, bind or otherwise interact with the active sensor, e.g., causing an increase or decrease in charge density of the active sensor or a change in current. Optionally, the membrane, filter or other functionalized structure may capture the target substance or ions, but allow the passage of other non-target ions. Optionally, a membrane, filter or other functionalized structure may block background charge, where a charge or lack of charge may be detected when a particle flows through a membrane and past the sensor.

The various reactions described herein may allow indirect detection, where the product of the reaction may diffuse to the surface of the sensor where it interacts with the sensor. This helps circumvent electrostatic screening issues that might otherwise arise.

In certain variations, the substrate may also include a control sensor (as described supra). The control sensor includes a second electrical component having an electrical characteristic. Binding of the chemical or biological substance to the active sensor or the control sensor does not result in a change in the electrical characteristic of the second electrical component of the control sensor.

The active and control sensor are used simultaneously, where both are disposed on the substrate. A differential between a signal from the first electrical component of the active sensor, the signal being indicative of the changed electrical characteristic or the change in the electrical characteristic, and a signal from the second electrical component of the control sensor may be used to determine the parameter of the chemical or biological substance in the sample of bodily fluid, as described supra.

In certain variations, the devices described herein may be part of a sensor or detection system. For example, the device may include, be coupled to, or be in communication with an analyzer. The analyzer may be configured to analyze the signals received from the first and/or second electrical components of the device or biosensor and to determine the differential between the signals. The system may also include a reader, where the reader includes, is coupled to or is in communication with the analyzer. The reader is configured to provide an electrical read-out of the analyzed signals and/or the determined parameter, based on the differential signal.

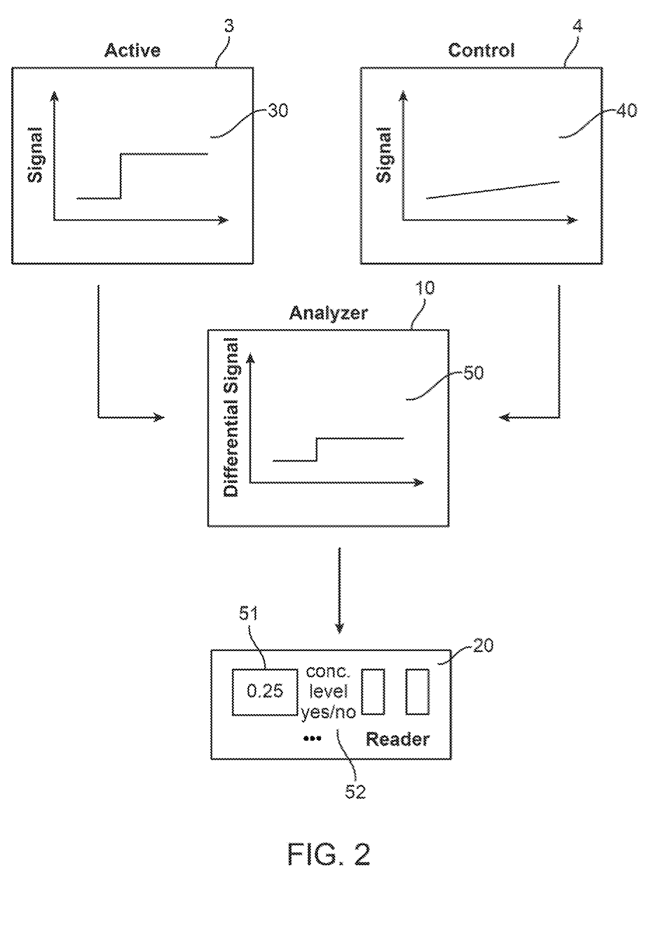

The analyzer may be used to receive or read the signal from the active and control sensors and to perform smart operations to convert measurements to accurate signal readouts and results for both sensors. The analyzer may include an analog/digital converter and/or a multiplexer. The analyzer may be used to provide a differential readout (See FIG. 2), and/or for amplifying the signals. The analyzer may include one or more source-meters or other electronics to apply a voltage or current, to apply a pulsed signal, to read-out a voltage, to read-out a current, and/or to read out a resistance and/or capacitance change or other electrical characteristic change.

The reader may connect to or be coupled to the device, to the analyzer, and/or to the device having an analyzer incorporated therein. The device may be in the form of a strip having a plurality of sensors as described supra. The reader may receive input from the analyzer, and may be used to visualize the detected and analyzed signals or results from the sensors of the device in a simple and user friendly way. The reader may include one or more source-meters or other electronics to apply a voltage or current, to apply a pulsed signal, to read-out a voltage, to read-out a current, and/or to read out a resistance and/or capacitance change or other electrical characteristic change.

In one variation, a device having one or more sensors and an analyzer, e.g., a device strip having a plurality of sensors as described herein, may be inserted into the reader to provide a user-friendly read-out regarding a parameter, (e.g., concentration) of the chemical or biological substance detected by the sensor. The reader may apply different voltages or currents or other electronic properties to the device strip or analyzer and it may receive or provide an output which may be visualized by a user in a simple and effective manner. Optionally, the reader may have capabilities or be configured to communicate via Bluetooth or Wi-Fi or via other wired or wireless mechanisms or modes of communication to one or more other device. Optionally, a controller may be provided, where the controller is coupled to or in communication with the device, e.g., the sensors, analyzer, and/or a reader, such that the controller may be used to control or program the functionality of the device, including the sensors and/or the analyzer. The controller may be coupled to the analyzer or be integrated in the reader. In certain variation, a controller may be located in the substrate (chip), analyzer or the reader.

In certain variations, methods for determining a parameter of a chemical or biological substance in a sample of bodily fluid includes one or more of the following steps. Providing a substrate having an active sensor and a control sensor, wherein the active sensor comprises a first electrical component having an electrical characteristic, wherein at least one functionalized structure is disposed on the substrate or the active sensor or in a location remote or separated from the substrate and active sensor, and wherein the control sensor comprises a second electrical component having an electrical characteristic. Coupling or binding the chemical or biological substance to a functionalized structure, wherein the bound chemical or biological substance undergoes a reaction thereby producing a product. Interacting the product with the first electrical component which results in a change in the electrical characteristic of the first electrical component, while not resulting in a change in the electrical characteristic of the second electrical component. Determining a differential between a first signal from the first electrical component of the active sensor, the first signal being indicative of the changed electrical characteristic or a change in the electrical characteristic, and a second signal from the second electrical component of the control sensor. Using the differential to determine the parameter of the chemical or biological substance in the sample of bodily fluid. Providing an electronic read-out of the determined parameter, based on the differential.

The functionalized structure may be positioned on the substrate or active sensor or in a location separate from the substrate, wherein the functionalized structure couples or binds the chemical or biological substance. Binding or coupling of the chemical or biological substance with the functionalized structure produces or results in the release of one or more ions which are detected by the first electrical component or cause a change in the electrical characteristic of the first electrical component.

The bound or coupled chemical or biological substance may undergo a reaction with one or more reagents which produces or results in the release of one or more ions which are detected by the first electrical component or cause a change in the electrical characteristic of the first electrical component.

The bound or coupled chemical or biological substance may undergo a reaction which produces or results in the release of one or more ions which cause a change in a pH or other ion concentration, wherein the change in pH other ion concentration is detected by the first electrical component or causes a change in the electrical characteristic of the first electrical component.

The bound chemical or biological substance may undergo a reaction in a first location which produces or results in the release of one or more products or ions which flow to the active sensor on the substrate positioned in a second, separate location, where the products or ions are detected by the first electrical component of the active sensor or cause a change in the electrical characteristic of the first electrical component of the active sensor.

The following documents are incorporated herein by reference in their entirety: Hammock, M. L. et al. Electronic readout ELISA with organic field-effect transistors as a prognostic test for preeclampsia; U.S. Provisional Pat. App. No. 61/907,363; and Mathias, W. et al. Selective Sodium Sensing with Gold-Coated Silicon Nanowire Field-Effect Transistors in a Differential Setup. ACS Nano 7, 5978-5983 (2013).

The devices, systems or methods for determining a parameter of and/or for detecting a chemical or biological substance in bodily fluid described herein may be utilized with various bodily fluids to detect various parameters of various substances.

Bodily fluid may include, e.g., blood, urine, saliva, tears, ejaculate, odor or other body fluids. Detected substances can include, e.g., hormones, different pathogens, proteins, antibodies, various drugs or therapeutics or other chemical or biological substances. Detected or determined parameters may include, e.g., pH changes, lactose changes, changing concentration, particles per unit time where a fluid flows over the device for a period of time to detect particles, e.g., particles that are sparse, and other parameters.

The various devices, systems or methods described herein may include one or more of the following features described below.

In certain variations, a plurality of conductors may be coupled to the active sensor and/or a plurality of conductors may be coupled to the control sensor. The conductors may be adapted to be electrically coupled to a reader for obtaining an electrical reading from the electrical components of the active and control sensors.

The chemical or biological substance may include, but not be limited to, a variety of substances, e.g., any substance suitable for detection or monitoring, such as, a therapeutic, drug, biological moiety, chemical moiety, protein, ion or antibody.

A variety of functionalized structures may be utilized, e.g. a protein, antibody, or chemical moiety (e.g., biotin). Any of these functionalized structures may be configured or suitable to bind to a therapeutic, drug, biological moiety, chemical moiety, protein, antibody, secondary antibody or ion in the sample of bodily fluid. In other variations, types of functionalized structures include, but are not limited to, a permeable membrane, hydrogel or other filter, e.g., PVC.

In one variation, a functionalized structure may include an antibody immobilized on the surface of the active sensor, and the antibody may be capable of binding to any of the chemical or biological substances described herein. In another variation, the functionalized structure may be a species specific antibody configured to bind antigen-specific polyclonal and monoclonal primary antibodies, where chemical bifunctional cross linkers may irreversibly connect the antibodies.

In certain variations, an immobilization structure may be disposed on or in a vicinity of a substrate or active sensor of a device, and a functionalized structure may be coupled to the immobilization structure. For example, the immobilization structure may include a high-K dielectric ALD layer. The high-K dielectric ALD layer may include, but not be limited to, aluminum oxide, titanium oxide, zirconium oxide, yttrium oxide, silicon oxide, tantalum oxide, hafnium oxide and silicon nitride. Optionally, the immobilization structure may include at least a portion made up of nanoparticles and/or a metal layer for adhering to the ALD layer.

In certain variations, the control sensor may be passivated. For example, the control sensor may include a passivation structure such as a self-assembled monolayer (SAM), metal, or polymer layer. The SAM may include alkane or aromatic thiols, aromatic silanes, or any chemical entity having a terminal group that is covalently attached to a surface, a spacer group having a hydrocarbon, or a head group, e.g., such as, —COOH, —CH3, —SH, —NH2, and —OH.

In any of the variations described herein, the device or substrate may be in the form of a disposable strip. The strip may include a plurality of active and/or control or passivated sensors positioned thereon. In certain variations, the device or strip may include an analyzer and/or a reader incorporated therein.

The device or strip may include a plurality of active sensors and/or control sensors. The signals generated by each sensor, e.g., signals resulting from a change to an electrical characteristic of the active sensors, may be read out. The average of all the determined parameter values based on each sensor, e.g., the concentration of a substance, may then be calculated or deduced.

In any of the various devices, systems or methods described herein, various electrical components or sensors may be utilized. The electrical component or sensor may be any suitable transistor, e.g. an OFET (organic field effect transistor) or FET (field effect transistor). For example, a FET may be of any suitable type, and may include a semiconducting layer doped with a n-type or p-type material. A source or source electrode and a drain or drain electrode may be formed in a spaced-apart position on two sides of the semiconducting layer. The source electrode and drain electrode may be each doped having an opposite polarity to the semiconducting layer. A suitable dielectric layer, such as an oxide layer, may underlie the semiconducting layer and the source and drain. A gate electrode underlies the dielectric layer. In other variations, the gate electrode may be on top of the FET or in its vicinity. A substrate layer made from any suitable material such as plastic or glass serves as a support layer and may underlie the gate electrode. In certain variations, the semiconducting layer may have a surface that is opposite to the surface to which the dielectric layer is adhered.

Any of the readers described herein may include electrical components for receiving, digitizing and analyzing the analog electrical signals received from the sensors or for controlling the sensor. Such electrical components may include a suitable computer processor or central processing unit, which may be electrically coupled to the electrical pickups of the reader that electrically engage the sensors, where such a feature is provided. The reader may further include suitable storage or memory, electrically coupled to the processor, for storing computer data. A suitable display can be included in the reader for displaying desired information. The display can be a touch screen, for additionally serving as an input device or terminal. A transmitter or transceiver can be included in the reader, and electrically coupled therein with a processor, for wirelessly transmitting or receiving information between the reader and a suitable remote device.

The reader, alone or in conjunction with another suitable computing device, can be calibrated to convert the change in electrical characteristic of the electrical component into a concentration level of the targeted drug or other substance. In one variation, a suitable algorithm can be provided in software and stored on a memory of the reader or on a remote device in communication with the reader, or programmed onto a chip provided on the reader, so as to permit a processor of the reader to manipulate or process the plurality of measurements provided by the sensors on the a device or strip and arrive at an immediate numerical concentration of the targeted substance.

### Exemplary Variations of Systems for Detecting a Biological or Chemical Substance in Bodily Fluid

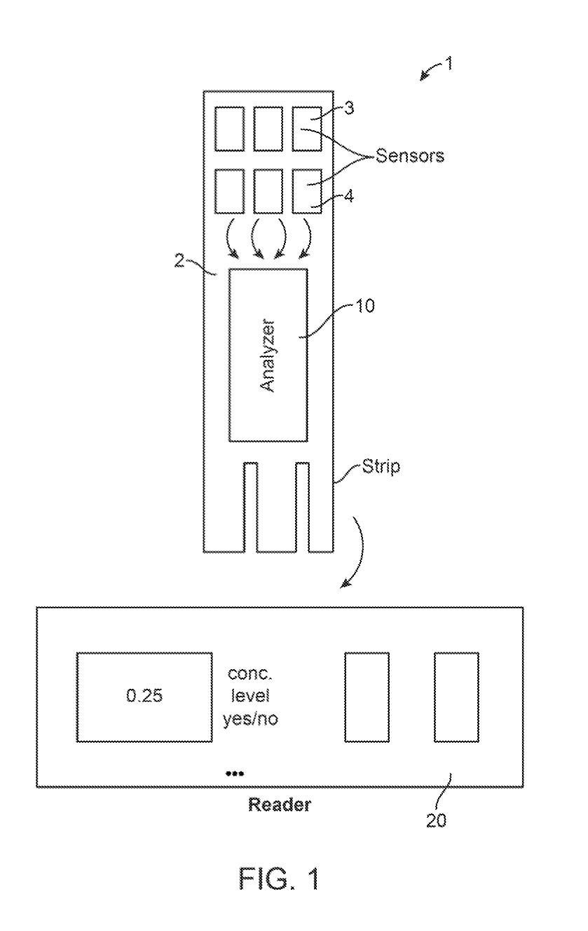

FIG. 1 illustrates a variation of a system 1 for determining a parameter of and/or for detecting a chemical or biological substance in a sample of bodily fluid. The system includes a substrate 2. One or more active sensors 3 and one or more control sensors 4 are disposed on the surface of the substrate 2. For example, FIG. 1 shows three active sensors 3 and three control sensors 4; however, it is contemplated that any suitable number of sensors or sensor pairings may be utilized.

The system 1 also includes an analyzer 10. The analyzer 10 is configured to analyze the signals received from the first electrical components of the active sensor 3 and the second electrical component of the control sensor 4. The system also includes a reader 20. The reader 20 is coupled to or in communication with the sensors 3, 4 and/or analyzer 10. The reader 20 is configured to receive an analyzed signal from the analyzer 10, and to provide an electronic read-out of the analyzed signal, e.g., in a visible, user-friendly mode. Optionally, a controller may be coupled to the analyzer or be integrated in the reader to provide control and/or programming.

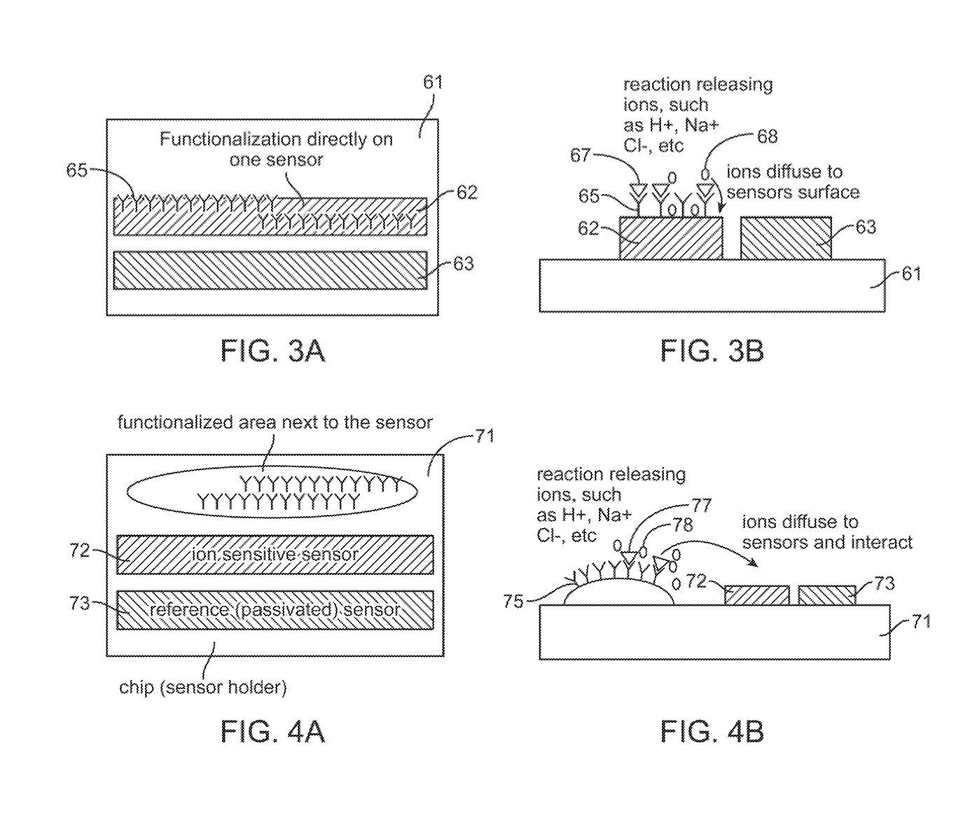

The active sensor 3 includes one or more first electrical components having an electrical characteristic or property. One or more functionalized structures (not shown), may be disposed on, near or in a vicinity of the substrate 2 or the active sensor 3. The functionalized structure and functionalized structure arrangement may include any of the functionalized structures described herein, e.g., including the functionalized structures illustrated in FIGS. 3A-6 (discussed below). The functionalized structure may interact with (e.g., couple with or bind) the chemical or biological substance. The interaction of the chemical or biological substance with the functionalized structure, or the interaction of an ion or product released or produced by a reaction involving a bound chemical or biological substance, may result in a change in the electrical characteristic or property of the electrical component of the active sensor 3.

The control sensor 4 includes one or more second electrical components having an electrical characteristic. The control sensor 4 is configured such that interaction of the chemical or biological substance with the active sensor 3 and/or the control sensor 4 does not result in a change in the electrical characteristic of the second electrical components of the control sensor 4. For example, the control sensor 4 may be passivated such that the target chemical or biological substance does not bind to or interact with the control sensor 4.

As illustrated with reference to the schematic in FIG. 2, the first electrical component of the active sensor 3 produces an active signal 30. The active signal 30 is indicative of the changed electrical characteristic or the change in the electrical characteristic of the first electrical component caused by the interaction of the functionalized group or the first electrical component with the chemical or biological substance in the bodily fluid, or a product (e.g., an ion) released from a reaction involving the chemical or biological substance. For example, the active signal 30 may be indicative of a change in current, voltage, capacitance or other electrical characteristic. Simultaneously, the second electrical component of the control sensor 4 produces a control signal 40. The analyzer 10 receives, as input, the active signal 30 from the active sensor 3 and the control signal 40 from the control sensor 4. The analyzer produces a differential signal 50, which is the difference between the active signal 30 and the control signal 40. The analyzer may convert the active and control signals from analog to digital. The differential signal 50 is then transmitted to the reader 20, and used to deduce a parameter, e.g., concentration of the chemical or biological substance in the sample of bodily fluid. The reader 20 than provides a read-out based on the differential signal, in the form of a value 51 of a parameter of the substance, e.g., the concentration of the substance, and/or by indicating whether or not the substance is or is not present 52 in the sample of bodily fluid.

The differential signal 50 may be used to determine a variety of parameters or characteristics of the chemical or biological substance, or to detect the presence of the chemical or biological substance. In certain variations, the differential signal 50 may be used to determine the concentration of various ions present in a target chemical or biological substance or in the sample of bodily fluid. For example, the differential signal 50 may be used to determine the pH of the target chemical or biological substance.

FIGS. 3A-3B illustrate one variation of a device or substrate 61 having one or more functionalized structures 65 disposed thereon. The substrate 61 includes an active sensor 62 and a control sensor 63. Functionalized structures 65 are disposed on the surface of the active sensor 62. As shown in FIG. 3B, a target chemical or biological substance 67 binds to one or more of the functionalized structure 65 and undergoes a reaction which produces one or more ions 68, which diffuse to the surface of the active sensor 62 where they interact with the active sensor 62 and cause a change in an electrical characteristic of the active sensor 62 and/or are detected by the active sensor 62.

FIGS. 4A-4B illustrate another variation of a device or substrate 71 having one or more functionalized structures 75 disposed thereon. The substrate 71 includes an active sensor 72 and a control sensor 73. Functionalized structures 75 are disposed on the surface of the substrate 71, adjacent to the active sensor 72.

As shown in FIG. 4B, a target chemical or biological substance 77 binds to one or more of the functionalized structure 75 and undergoes a reaction which produces one or more ions 78, which diffuse to or flow over to the surface of the active sensor 72 where they interact with the active sensor 72 and cause a change in an electrical characteristic of the active sensor 72 and/or are detected by the active sensor 72.

The various devices described herein may utilize or work with a variety of functionalized structures and functionalized structure arrangements, as well as reactions between target chemical or biological substances and a functionalized structure and/or other reagents, to determine and/or detect various parameters of chemical or biological substances.

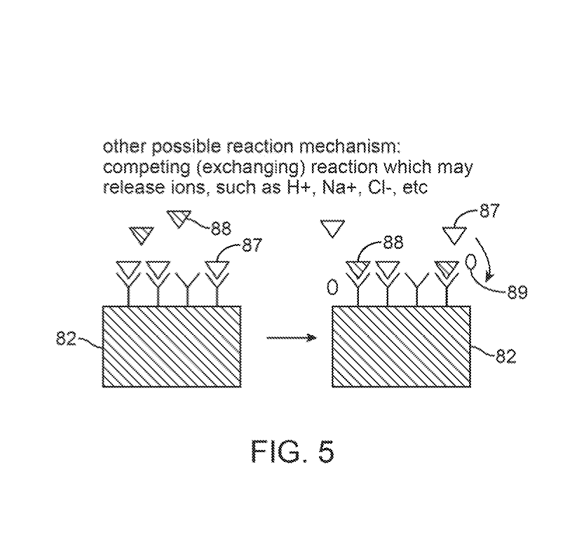

FIG. 5 illustrates a variation of an active sensor 82. Functionalized structures 85 are disposed on the surface of the active sensor 82. In this variation, a first moiety 87 and a second moiety 88 of a target chemical or biological substance undergo a competing reaction which produces ions 89, as the two moieties exchange binding position on the functionalized structure 85. The ions 89 then diffuse to the surface of the active sensor 82 where they interact with the active sensor 82 and cause a change in an electrical characteristic of the active sensor 82 and/or are detected by the active sensor 82.

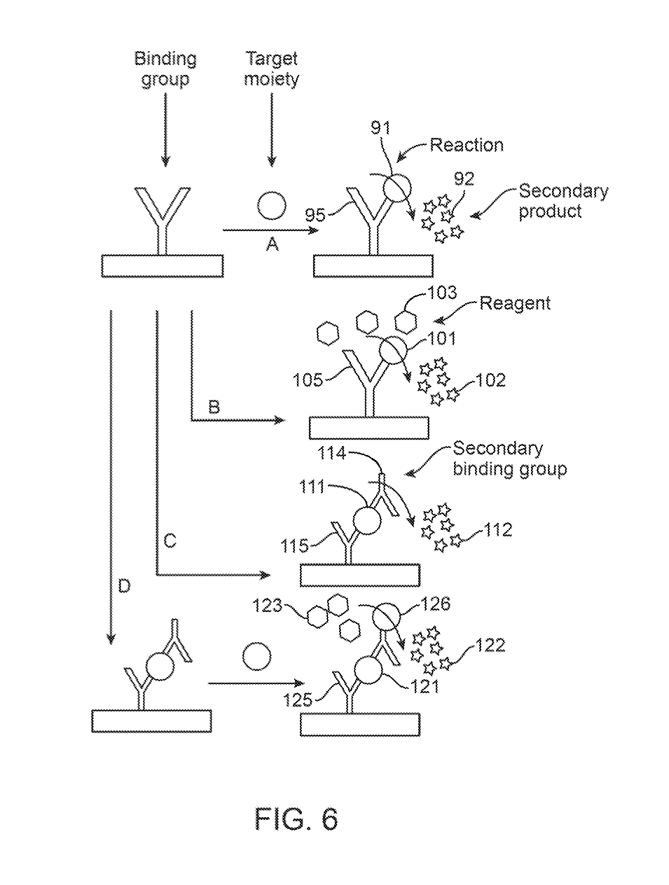

FIG. 6 illustrates various reactions that may be utilized with the sensor devices and systems described herein, which involve a chemical or biological substance binding to a functionalized structure disposed on a substrate, active sensor or in a location remote or separate from the sensor device or substrate. The reactions involve various functionalization schemes as described in more detail below.

In reaction A, a target moiety 91 binds functionalized structure 95, where the binding results in the production of a secondary product 92, which will effect a change in an electrical characteristic of an active sensor.

In reaction B, a target moiety 101 binds functionalized structure 105. The bound target moiety 101 undergoes a reaction with reagent 103, which results in the production of a secondary product 102, which will effect a change in an electrical characteristic of an active sensor.

In reaction C, a target moiety 111 binds functionalized structure 115. The bound target moiety 111 binds a secondary functionalized structure 114. The binding of the secondary functionalized structure 114 results in the production of a secondary product 112, which will effect a change in an electrical characteristic of an active sensor.

In reaction D, a first target moiety 121 binds functionalized structure 125. The bound fist target moiety 121 binds a secondary functionalized structure 124. The secondary functionalized structure 124 binds a second target moiety 126. The bound second target moiety 126 undergoes a reaction with reagent 123, which results in the production of a secondary product 122, which will effect a change in an electrical characteristic of an active sensor.

In another example of a reaction, the reaction may include a species specific antibody (e.g. anti mouse, anti rabbit, anti goat, anti guinea pig, anti rat, anti lama), which is immobilized onto the sensor surface or other location separate from the sensor. Antigen-specific polyclonal and monoclonal primary antibodies raised in, e.g. mouse, rabbit, goat, guinea pig, rat or lama may be added and recognized by the secondary antibody immobilized to the sensor surface or other surface. For a stable interaction, chemical bifunctional cross linkers will be used to irreversibly connect both antibodies.

In other variations, peptides, oligos, ligands or other structures or molecules may be utilized to provide functionalization to a sensor or other surface. The functionalized structures may be involved or take part in various reactions, which can be detected or produce products that can be detected by the sensor.

In certain variations, the devices, systems and methods described herein may provide point-of-care, portable and real-time diagnostic tools. They may provide an electronic readout of an enzyme linked immunosorbent assay (ELISA) or other assays to detect various chemical or biological substances. The electronic components may be configured to transduce or convert a biochemical binding event or reaction into an electrical signal, which may be read out. Indirect detection of a freely diffusing, electronically active species produced at the site of a bound chemical or biological substance may be performed utilizing the described biosensor devices. Electronic readout ELISA schemes where an enzyme capable of producing an electronically active species may be utilized.

In one variation, indirect detection may be utilized in a device or system described herein where a surface is functionalized with capture antibodies (Abs) in order to provide specific binding site. In one example, fms-like tyrosine kinase (sFlt1) may be detected. After sFlt1 is introduced to the device, it binds to the previously immobilized capture Abs. A secondary, biotin-labeled detection Ab is then introduced, which binds to a different epitope of sFlt1. Streptavidin (SA) conjugated GOx (SA-GOx) tagged enzyme is introduced to bind specifically to the detection Ab. Finally, glucose is introduced and the enzyme-mediated conversion of glucose to gluconic acid elicits a pH change that can be measured by the sensor.

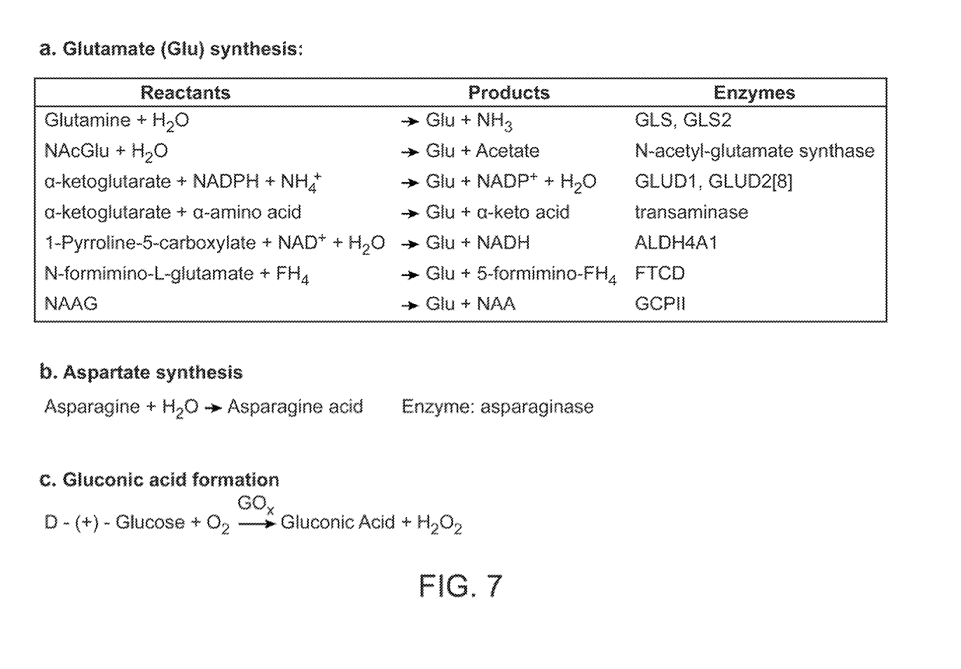

FIG. 7 shows examples of reactions which cause secondary cascade reactions, which may be utilized with the devices described herein. The reactions listed in FIG. 7 are merely examples and not meant to be limiting, as other reactions my also cause secondary cascade reactions.

In certain variations, a functionalization area close to the sensor system or on the sensor surface where a functionalization and reaction take place is provided. The functionalization area may include an oxide surface, nanoparticles, a metal, polymer or any other kind of material. The functionalization can be a protein, antibody or a chemical moiety immobilized using a linker, which may consist of a chemical surface modification, immobilization linkers (such as ProLinker™) or anything else which allows to bind the functionalization moiety to the desired surface.

In certain variations, the functionalization can be in the form of an assay, e.g. sandwich assay. A reagent may be introduced to the sensor starting a cascade reaction creating the release of a moiety, e.g. ions. Secondary reagents may freely diffuse to the sensor surface or may be pushed to the surface using a force (e.g. pumps, capillary forces, etc).

In certain variations, a competing reaction may take place exchanging a previously captured moiety with another one, where the exchange of the moiety releases secondary ions.

In other variations, indirect detection of a freely diffusing, electronically active species produced at the site of an Anitbody-immobilized analyte or other peptide may be performed. The reaction can create a change in the concentration of the released secondary ions. It may cause a change in pH (acid or base). Ions that can be released can be but are not limited to H+, Na+, K+, Cl—, COOH.

Any of the functionalization schemes and reactions described herein may take place in a first location remote from or separated from the sensor or device located in a second location. The reaction products or ions may then flow to and/or over the sensor or device where detection takes place.

Each of the individual variations described and illustrated herein has discrete components and features which may be readily separated from or combined with the features of any of the other variations. Modifications may be made to adapt a particular situation, material, composition of matter, process, process act(s) or step(s) to the objective(s), spirit or scope of the present invention.

Methods recited herein may be carried out in any order of the recited events which is logically possible, as well as the recited order of events. Furthermore, where a range of values is provided, every intervening value between the upper and lower limit of that range and any other stated or intervening value in that stated range is encompassed within the invention. Also, any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail). The referenced items are provided solely for their disclosure prior to the filing date of the present application. Nothing herein is to be construed as an admission that the present invention is not entitled to antedate such material by virtue of prior invention.

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise, all technical and scientific terms used herein have the same meaning as commonly understood by one of ordinary skill in the art to which this invention belongs.

This disclosure is not intended to be limited to the scope of the particular forms set forth, but is intended to cover alternatives, modifications, and equivalents of the variations described herein. Further, the scope of the disclosure fully encompasses other variations that may become obvious to those skilled in the art in view of this disclosure. The scope of the present invention is limited only by the appended claims.

1. A device for determining a parameter of a chemical or biological substance in a sample of bodily fluid, the device comprising:
a substrate having an active sensor and a control sensor;
wherein the active sensor comprises a first electrical component having an electrical characteristic, wherein at least one functionalized structure is disposed on or in a vicinity of the substrate or active sensor, wherein the functionalized structure is configured to interact with the chemical or biological substance such that interaction of the chemical or biological substance with the functionalized structure results in a change in the electrical characteristic of the first electrical component;
wherein the control sensor comprises a second electrical component having an electrical characteristic, wherein interaction of the chemical or biological substance with the active sensor or the control sensor does not result in a change in the electrical characteristic of the second electrical component; and
wherein a differential between a first signal from the first electrical component of the active sensor, the first signal being indicative of the changed electrical characteristic of the first electrical component, and a second signal from the second electrical component of the control sensor is used to determine the parameter of the chemical or biological substance in the sample of bodily fluid.

2. The device of claim 1, wherein the functionalized structure is positioned on the substrate or active sensor or in a location separate from the substrate, wherein the functionalized structure is configured to bind the chemical or biological substance, wherein binding of the chemical or biological substance with the functionalized structure produces or results in the release of one or more ions which are detected by the first electrical component or cause a change in the electrical characteristic of the first electrical component.

3. The device of claim 1, wherein the functionalized structure is positioned on the substrate or active sensor or in a location separate from the substrate, wherein the functionalized structure is configured to bind the chemical or biological substance, wherein the bound chemical or biological substance undergoes a reaction with one or more reagents which produces or results in the release of one or more ions which are detected by the first electrical component or cause a change in the electrical characteristic of the first electrical component.

4. The device of claim 1, wherein the substrate is positioned in a first location and the functionalized structure is positioned in a second location separate from the substrate, wherein the functionalized structure is configured to bind the chemical or biological substance, wherein the bound chemical or biological substance undergoes a reaction which produces or results in the release of one or more products or ions which flow to the active sensor on the substrate, where the products or ions are detected by the first electrical component of the active sensor or cause a change in the electrical characteristic of the first electrical component of the active sensor.

5. The device of claim 1, wherein the determined parameter of the chemical or biological substance in the sample of bodily fluid is concentration, wherein the differential between the signal of the active sensor and the signal of the control sensor is indicative of or corresponds to the concentration of the chemical or biological substance in the sample of bodily fluid.

6. The device of claim 1, further comprising a plurality of conductors coupled to the active sensor and a plurality of conductors coupled to the control sensor, wherein the conductors are adapted to be electrically coupled to a reader for obtaining an electrical reading from the electrical components of the active and control sensors

7. The device of claim 1, wherein the control sensor is passivated.

8. The device of claim 1, wherein the chemical or biological substance includes, a therapeutic, drug, biological moiety, chemical moiety, protein, ion, antibody, peptides, oligos, or ligands.

9. The device of claim 1, wherein the functionalized structure includes a protein antibody or chemical moiety (e.g., biotin) configured to bind to a therapeutic, drug, protein, biological moiety, chemical moiety, protein, ion or antibody in the sample of bodily fluid.

10. The device of claim 1, wherein the functionalized structure includes a permeable membrane, hydrogel, PVC or other filter, for allowing only the passage of a target ion.

11. The device of claim 1, wherein the functionalized structure includes an antibody, peptide or oligo immobilized on the surface of the active sensor, wherein the antibody is configured to bind to a secondary antibody.

12. The device of claim 1, further comprising at least one immobilization structure disposed on or in a vicinity of the substrate or active sensor, wherein the at least one functionalized structure is coupled to the immobilization structure.

13. The device of claim 12, wherein the immobilization structure may include a high-κ dielectric ALD layer.

14. The device of claim 13, wherein the high-κ dielectric ALD layer is selected from the group consisting of aluminum oxide, titanium oxide, zirconium oxide, yttrium oxide, silicon oxide, tantalum oxide, hafnium oxide and silicon nitride.

15. The device of claim 12, wherein the immobilization structure includes a portion selected from the group consisting of nanoparticles and a metal layer for adhering to the ALD layer.

16. The device of claim 1, wherein the electrical components are selected from the group consisting of a transistor, a capacitor, a resistor and an inverter.

17. The device of claim 1, wherein the control sensor includes a passivation structure such as a self-assembled monolayer (SAM), metal, or polymer layer.

18. The device of claim 17, wherein the SAM comprises alkane or aromatic thiols, aromatic silanes, or any chemical entity having a terminal group that is covalently attached to a surface, a spacer group having a hydrocarbon, or a head group selected from the group consisting of —COOH, —CH3, —SH, —NH₂, and —OH.

19. The device of claim 1, wherein the substrate is a disposable strip, wherein a plurality of active and control sensors are positioned on the disposable strip.

20.-41. (canceled)

42. A system for determining a parameter of a chemical or biological substance in a sample of bodily fluid, the system comprising:
a substrate having an active sensor and a control sensor;
wherein the active sensor comprises a first electrical component having an electrical characteristic, wherein at least one functionalized structure is disposed on or in a vicinity of the substrate or the active sensor, wherein the functionalized structure is configured to couple to the chemical or biological substance, wherein the bound chemical or biological substance undergoes a reaction thereby producing a product, wherein the product interacts with the first electrical component which results in a change in the electrical characteristic of the first electrical component;
wherein the control sensor comprises a second electrical component having an electrical characteristic, wherein coupling of the chemical or biological substance to the active sensor or the control sensor does not result in a change in the electrical characteristic of the second electrical component;
wherein a differential between a first signal from the first electrical component of the active sensor, the first signal being indicative of the changed electrical characteristic, and a second signal from the second electrical component of the control sensor is used to determine the parameter of the chemical or biological substance in the sample of bodily fluid;
an analyzer configured to analyze the signals received from the first and second electrical components and to determine the differential signal; and
a reader, wherein the reader is in communication with the analyzer, and the reader is configured to provide an electronic read-out of the determined parameter.

43. A method for determining a parameter of a chemical or biological substance in a sample of bodily fluid, the method comprising:
providing a substrate having an active sensor and a control sensor, wherein the active sensor comprises a first electrical component having an electrical characteristic, wherein at least one functionalized structure is disposed on or in a vicinity of the substrate or the active sensor and wherein the control sensor comprises a second electrical component having an electrical characteristic;
coupling the chemical or biological substance to a functionalized structure, wherein the bound chemical or biological substance undergoes a reaction thereby producing a product, wherein the product interacts with the first electrical component which results in a change in the electrical characteristic of the first electrical component, while not resulting in a change in the electrical characteristic of the second electrical component;
determining a differential between a first signal from the first electrical component of the active sensor, the first signal being indicative of the changed electrical characteristic, and a second signal from the second electrical component of the control sensor;
using the differential to determine the parameter of the chemical or biological substance in the sample of bodily fluid; and
providing an electronic read-out of the determined parameter.

44. The method of claim 43, wherein the functionalized structure is positioned on the substrate or active sensor or in a location separate from the substrate, wherein the functionalized structure binds the chemical or biological substance, wherein binding of the chemical or biological substance with the functionalized structure produces or results in the release of one or more ions which are detected by the first electrical component or cause a change in the electrical characteristic of the first electrical component.

45. The method of claim 43, wherein the functionalized structure is positioned on the substrate or active sensor or in a location separate from the substrate, wherein the functionalized structure binds the chemical or biological substance, wherein the bound chemical or biological substance undergoes a reaction with one or more reagents which produces or results in the release of one or more ions which are detected by the first electrical component or cause a change in the electrical characteristic of the first electrical component.

46. The method of claim 43, wherein the functionalized structure is positioned on the substrate or active sensor or in a location separate from the substrate, wherein the functionalized structure binds the chemical or biological substance, wherein the bound chemical or biological substance undergoes a reaction which produces or results in the release of one or more ions which cause a change in a pH other ion concentration, wherein the change in pH other ion concentration is detected by the first electrical component or causes a change in the electrical characteristic of the first electrical component.

47. The method of claim 43, wherein the substrate is positioned in a first location and the functionalized structure is positioned in a second location separate from the substrate, wherein the functionalized structure binds the chemical or biological substance, wherein the bound chemical or biological substance undergoes a reaction which produces or results in the release of one or more products or ions which flow to the active sensor on the substrate, where the products or ions are detected by the first electrical component of the active sensor or cause a change in the electrical characteristic of the first electrical component of the active sensor.
